(19) United States
(12) Patent Application Publication
(10) Pub. No.: US 2026/0245335 A1
(43) Pub. Date: Aug. 20, 2026

(54) IMAGE PROCESSING DEVICE, IMAGE PROCESSING METHOD, AND NON-TRANSITORY COMPUTER-READABLE MEDIUM

(71) Applicant: NEC Corporation, Tokyo (JP)

(72) Inventors: Masahito SAKAI, Tokyo (JP); Kosuke TONO, Tokyo (JP); Daisuke MORI, Tokyo (JP); Hisahiro OBA, Tokyo (JP)

(73) Assignee: NEC Corporation, Tokyo (JP)

(21) Appl. No.: 19/162,583

(22) PCT Filed: Mar. 23, 2023
(86) PCT No.: PCT/JP2023/011579

§ 371 Date: Sep. 5, 2025

(51) Int. Cl. G06V 10/26; G06F 21/62; G06V 10/25; G06V 20/58; G06V 40/10

(52) U.S. Cl. CPC G06V 10/267; G06F 21/6254; G06V 10/25; G06V 20/58; G06V 40/10

(57) ABSTRACT

An image processing device comprises: an image acquisition unit that acquires an image; a person region detection unit that detects, from the image, a person region presumed to be a person; a parameter acquisition unit that acquires an imaging environment parameter when the image was imaged by an imaging device; a first masking unit that masks at least a portion of the region if the imaging environment parameter satisfies a prescribed condition; and a second masking unit that masks a range resulting from at least partially expanding the person region, if the imaging environment parameter does not satisfy the prescribed condition.

### TECHNICAL FIELD

The present disclosure relates to an image processing device, an image processing method, and a non-transitory computer-readable medium.

### BACKGROUND ART

Videos acquired by an imaging device such as a drive recorder provided in a vehicle are collected and used for various purposes. In a case where a person or the like is shown in a video, from the perspective of personal information protection, masking processing may be performed on a region where the person is shown.

PTL 1 describes a technology of performing concealment processing such as mosaicing or blurring on a region of a non-monitored person subject to privacy protection based on an evaluation value for each person.

### CITATION LIST

### Patent Literature

PTL 1: JP 2011-130203 A

### SUMMARY OF INVENTION

### Technical Problem

However, there is a case where a person cannot be appropriately detected. For example, in a case where the imaging environment is poor, the person cannot be detected well, and a part of a face or a body may be excluded from the detection object. Therefore, there is a case where the masking processing on the person cannot be performed for personal information protection.

The present disclosure has been made to solve such a problem, and an object of the present disclosure is to provide an image processing device, an image processing system, an image processing method, and a non-transitory computer-readable medium capable of accurately detecting a region of a person from an image and performing masking processing.

### Solution to Problem

According to an aspect of the present disclosure, there is provided an image processing device including
an image acquisition unit that acquires an image,
a person region detection unit that detects a person region estimated to be a person from the image,
a parameter acquisition unit that acquires an imaging environment parameter when the image is captured by an imaging device,
a first masking unit that masks at least a part of the person region in a case where the imaging environment parameter satisfies a predetermined condition, and
a second masking unit that masks a range obtained by at least partially expanding the person region in a case where the imaging environment parameter does not satisfy the predetermined condition.

According to another aspect of the present disclosure, there is provided an image processing method including
acquiring an image,
detecting a person region estimated to be a person from the image,
acquiring an imaging environment parameter when the image is captured by an imaging device,
masking at least a part of the person region in a case where the imaging environment parameter satisfies a predetermined condition, and
masking a range obtained by at least partially expanding the person region in a case where the imaging environment parameter does not satisfy the predetermined condition.

According to still another aspect of the present disclosure, there is provided a non-transitory computer-readable medium storing a program that causes a computer to
acquire an image,
detect a person region estimated to be a person from the image,
acquire an imaging environment parameter when the image is captured by an imaging device,
mask at least a part of the person region in a case where the imaging environment parameter satisfies a predetermined condition, and
mask a range obtained by at least partially expanding the person region in a case where the imaging environment parameter does not satisfy the predetermined condition.

### Advantageous Effects of Invention

According to the present disclosure, it is possible to provide an image processing device and the like capable of accurately detecting a region of a person from an image and performing masking processing.

### BRIEF DESCRIPTION OF DRAWINGS

FIG. 1 is a block diagram illustrating a configuration of an image processing device according to a first example embodiment.

FIG. 2 is a diagram illustrating an example of an acquired video frame according to the first example embodiment.

FIG. 3 is a diagram illustrating another example of an acquired video frame according to the first example embodiment.

FIG. 4 is a flowchart illustrating an image processing method according to the first example embodiment.

FIG. 5 is a block diagram illustrating a configuration of an image processing system according to a second example embodiment.

FIG. 6 is a block diagram illustrating a configuration of an image processing device according to the second example embodiment.

FIG. 7 is a flowchart illustrating an image processing method according to the second example embodiment.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description.

### First Example Embodiment

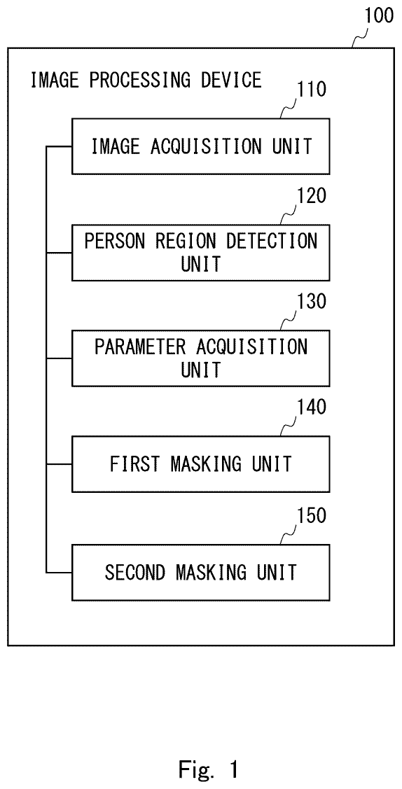

FIG. 1 is a block diagram illustrating a configuration of an image processing device 100 according to a first example embodiment. In a case where an image acquired from an imaging device that images the surroundings of a vehicle or a road includes a person, the image processing device 100 performs masking processing for concealing the person, their clothing, and the like in such a way as not to be able to be identified. The image processing device 100 includes an image acquisition unit 110, a person region detection unit 120, a parameter acquisition unit 130, a first masking unit 140, and a second masking unit 150. The image processing device 100 can be implemented by a computer including a processor and a memory. The image processing device 100 is connected to a wired or wireless network (not illustrated). An imaging device (not illustrated) or the like that images the surroundings of a vehicle is connected to the network. A video captured by the imaging device is a moving image and includes a plurality of consecutive frames arranged in chronological order of an imaging time. Here, a frame is still image data captured by the imaging device.

The image acquisition unit 110 acquires image frames of a video captured by the imaging device installed in the vicinity of a vehicle, a road, or the like. The video includes a plurality of frames. The video captured by the imaging device is transmitted to the image processing device 100 via the network.

The person region detection unit 120 detects a person region estimated to be a person from the video acquired by the image acquisition unit 110. Specifically, the person region detection unit 120 detects the person region for each frame included in the video using a known person region detection engine.

The parameter acquisition unit 130 acquires an imaging environment parameter when an image is captured by the imaging device. The imaging environment parameter includes imaging-date-and-time data. The imaging environment parameter is data from various sensors provided in the vehicle.

Examples of the sensor include a vehicle speed sensor, an optical sensor (including, for example, a charge-coupled device (CCD) or complementary metal-oxide semiconductor (CMOS) phototransistor), and a weather sensor, but are not limited to these examples.

In a case where the imaging environment parameter satisfies a predetermined condition, the first masking unit 140 masks at least a part or all of the person region. That is, in a case where the imaging environment parameter satisfies a predetermined condition, the first masking unit 140 determines that a person is appropriately detected by a person detection engine and a bounding box includes the entire body of the person, and performs various concealment processing on at least a part or all of the person region in such a way as not to be identified as a person. Examples of masking include filling, mosaicing, and blurring on at least a part of the person region and the face region, but are not limited to thereto. Various masking methods that can be understood by those of ordinary skill in the art can be employed.

In a case where the imaging environment parameter does not satisfy the predetermined condition, the second masking unit 150 masks a range obtained by at least partially expanding the detected person region. That is, in a case where the imaging environment parameter does not satisfy the predetermined condition, the second masking unit 150 determines that a person is not appropriately detected by the person detection engine, the bounding box does not include the entire body of the person, and a part of the face or the body is partially excluded, and masks a range obtained by at least partially or entirely expanding the person region. Thus, even in a case where the imaging environment is poor, it is possible to mask the face or the body outside the detected person region (bounding box) without excluding a part of the face or the body.

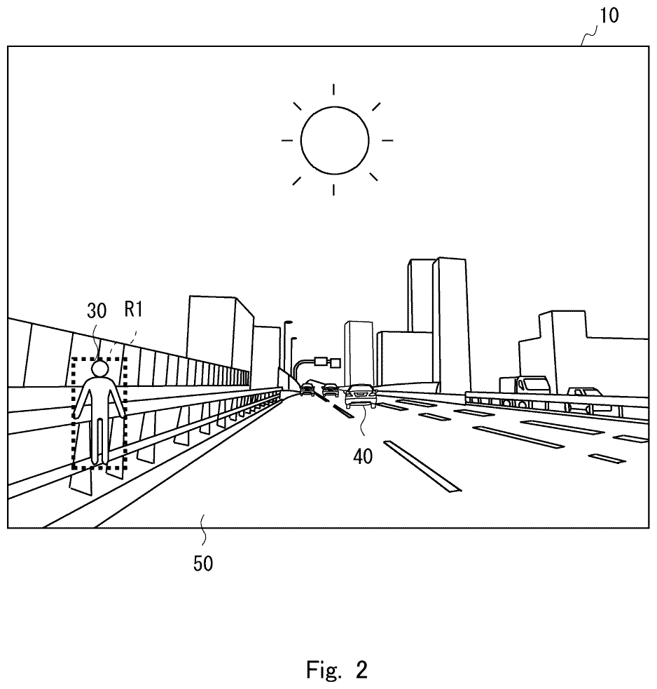

FIG. 2 illustrates an example of a frame 10 included in the acquired video. In the frame 10 illustrated in FIG. 2, a person 30 walking on a sidewalk and a vehicle 40 traveling forward on a roadway 50 are shown. In the example in FIG. 2, the person region detection unit 120 appropriately detects a person region R1 that is a region including an image of the person 30. In FIG. 2, for example, since the imaging is performed in the daytime, and the brightness, which is the acquired parameter, is within a predetermined range (that is, equal to or more than a lower limit threshold and equal to or less than an upper limit threshold), the person detection accuracy of the person region detection unit 120 is high, and the entire body of the person fits exactly within the bounding box. In the present disclosure, the first masking unit performs masking processing on the inside of the person region (bounding box) to ensure personal information protection.

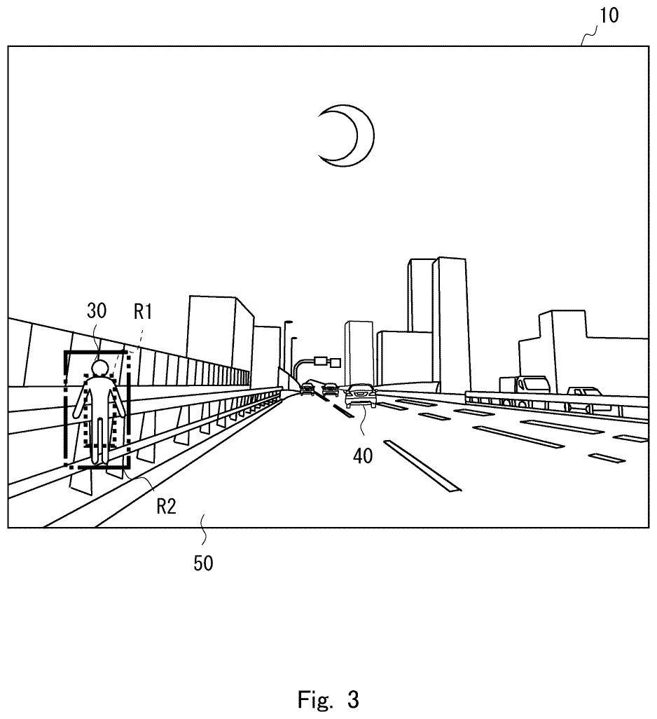

FIG. 3 illustrates another example of the frame 10 included in the acquired video.

In the example of FIG. 3, the person region RI detected by the person region detection unit 120 includes only a part of the body part of the person 30. Since the face of the person 30 is not included in the person region, the masking processing is not performed. In the present disclosure, as described above, in a case where the parameter of the brightness is acquired and the brightness is outside a predetermined range (that is, since the imaging is performed in the nighttime, the parameter is less than a lower limit threshold), the second masking unit masks a region R2 obtained by expanding the person region RI by a predetermined amount. In the present example, the expansion region R2 is formed by expanding the person region RI in such a way that a part of the face or limbs is also included.

The predetermined condition described here is merely an example, and various conditions for appropriately detecting the person region, which can be understood by those of ordinary skill in the art, can be used. For example, the predetermined condition includes the brightness being equal to or more than a lower limit threshold and equal to or less than an upper limit threshold, the variance of the pixel values being equal to or more than a lower limit threshold and equal to or less than an upper limit threshold, the speed of a vehicle being equal to or less than a threshold, the weather being sunny, and the detected object having an appropriate size (relatively close to the imaging device of the vehicle). The brightness may be the brightness of the entire image or the brightness within the bounding box.

On the other hand, a condition for expanding the masking is applied to a case where the above-described predetermined condition is not satisfied. The condition for expanding the masking includes the brightness being less than the lower limit threshold or more than the upper limit threshold, the variance of the pixel values being less than the lower limit threshold or more than the upper limit threshold, the speed of a vehicle being more than a threshold (that is, high speed), the weather being rainy, snowy, or the like, and the detected object being very small (very far from the imaging device of the vehicle).

The image processing device 100 includes a processor, a memory, and a storage device as components (not illustrated). The storage device stores a computer program in which processing of the image processing method according to the present example embodiment is implemented. The processor loads the computer program from the storage device into the memory and executes the computer program. Thus, the processor achieves functions as the image acquisition unit 110, the person region detection unit 120, the parameter acquisition unit 130, the first masking unit 140, and the second masking unit 150.

The image acquisition unit 110, the person region detection unit 120, the parameter acquisition unit 130, the first masking unit 140, and the second masking unit 150 may be implemented by dedicated hardware. Some or all of the components of each device may be implemented by general-purpose or dedicated circuitry, a processor, or a combination thereof. These components may be configured with a single chip or may be configured with a plurality of chips connected via a bus. Some or all of the components of each device may be implemented by a combination of the above-described circuitry or the like and a program. A central processing unit (CPU), a graphics processing unit (GPU), a field-programmable gate array (FPGA), or the like can be used as the processor.

In a case where some or all of the components of the image processing device 100 are implemented by a plurality of information processing devices, circuitry, or the like, the plurality of information processing devices, circuitry, or the like may be centralized or distributed. For example, each of the information processing devices, circuitry, or the like may be implemented in the form of a client server system, a cloud computing system, or the like in which they are connected to each other through a communication network. A function of the image processing device 100 may be provided in a software as a service (Saas) format.

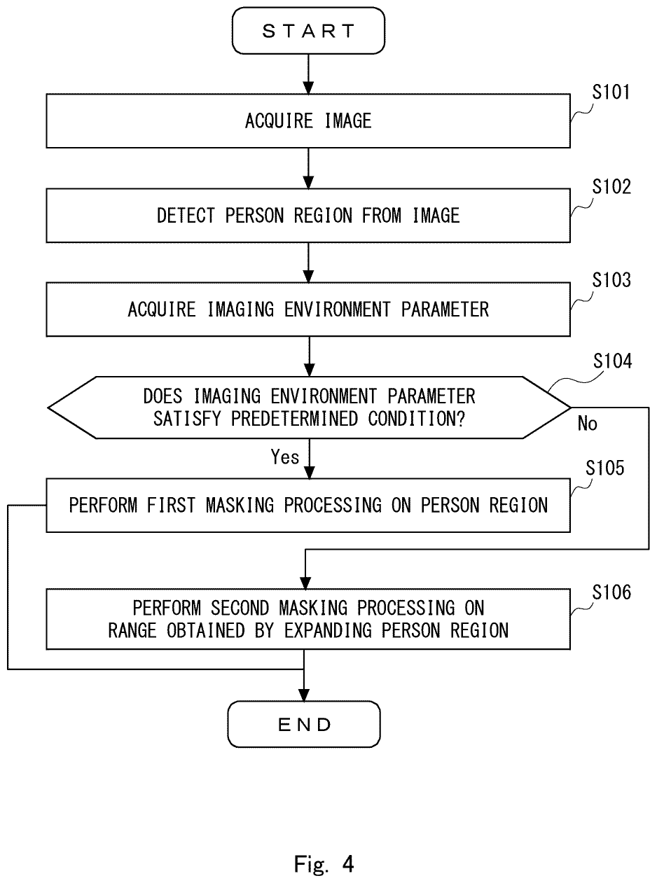

FIG. 4 is a flowchart illustrating the image processing method according to the first example embodiment.

The image acquisition unit 110 acquires image frames of a video captured by the imaging device installed in the vicinity of a vehicle, a road, or the like (step S101). The acquired image frames are stored in the storage device together with an acquired time and an acquired positional information (for example, latitude, longitude, and the like).

The person region detection unit 120 detects a person region estimated to be a person from the video acquired by the image acquisition unit 110 using the known person region detection engine (step S102).

The parameter acquisition unit 130 acquires an imaging environment parameter when an image is captured by the imaging device (step S103). The acquired imaging environment parameter is stored in the storage device together with an acquired time and an acquired positional information (for example, latitude, longitude, and the like).

In a case where an imaging environment parameter satisfies a predetermined condition (that is, in a case where the detected person is considered to be appropriately included within the bounding box) (Yes in step S104), the first masking unit 140 masks at least a part or all of the person region (step S105). Thereafter, the image processing ends. Thus, it is possible to perform concealment processing on the person correctly included within the bounding box in the image frame using the person region detection engine.

On the other hand, even in a case where the imaging environment parameter does not satisfy the predetermined condition (that is, in a case where there is a high possibility that the person is not correctly included within the bounding box in the image frame using the person region detection engine) (No in step S104), the personal information protection can be ensured by performing the masking processing while expanding the detected person region. The second masking unit 150 masks a range obtained by expanding the person region at least partially (step S106). The range to be expanded may be changed stepwise according to the acquired parameter value. In some example embodiments, for example, if the acquired parameter is equal to or more than a first threshold, the person region may be expanded 1.2 times, and if the acquired parameter is equal to or more than a second threshold larger than the first threshold, the person region may be expanded 1.5 times. In another example embodiment, a function that determines the expansion range based on the value of the parameter may be used. Thus, even in a case where the accuracy of the person region detection engine is not good (for example, due to external environmental factors such as weather), it is possible to perform masking processing without excluding a person whose personal information is to be protected.

### Second Example Embodiment

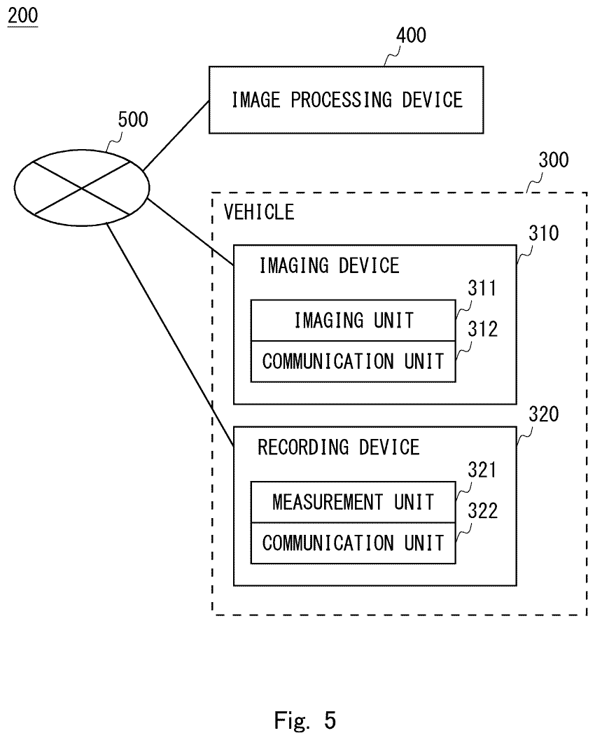

FIG. 5 is a block diagram illustrating a configuration of an image processing system 200 according to a second example embodiment. The image processing system 200 may include at least an imaging device 310 and an image processing device 400, and may further include a recording device 320. The imaging device 310 and the recording device 320 are connected to the image processing device 400 via a network 500. Description overlapping with the first example embodiment will be omitted as appropriate.

The image processing system 200 detects a person from a video captured by the imaging device 310 provided in a vehicle 300, and masks the person. The vehicle 300 is, for example, an automobile and may be a vehicle other than the automobile such as a motorcycle or a bicycle. The imaging device 310 and the recording device 320 are provided in the vehicle 300. The imaging device 310 is a device that images a scene around the vehicle 300 and is, for example, a drive recorder. The imaging device 310 includes an imaging unit 311 and a communication unit 312. The imaging unit 311 is a camera. The imaging unit 311 images, for example, a scene in front of the vehicle 300, that is, a scene that a driver sitting in a driver's seat of the vehicle 300 can see. The orientation of the imaging unit 311 can be arbitrarily changed or may be in all directions. The communication unit 312 is a communication interface with the network 500. The communication unit 312 transmits the video captured by the imaging unit 311 to the image processing device 400 via the network 500.

The recording device 320 acquires and records the imaging environment parameter at the time of imaging. For example, the imaging environment parameter includes a traveling speed of the vehicle 300, brightness around the imaging device 310 and around a subject, and variance of pixel values. The recording device 320 includes a measurement unit 321 and a communication unit 322. The measurement unit 321 measures an environmental parameter using various sensors provided in the vehicle 300 or the imaging device 310. The communication unit 322 is a communication interface with the network 500. The communication unit 322 transmits the environmental parameter measured by the measurement unit 321 to the image processing device 400 via the network 500.

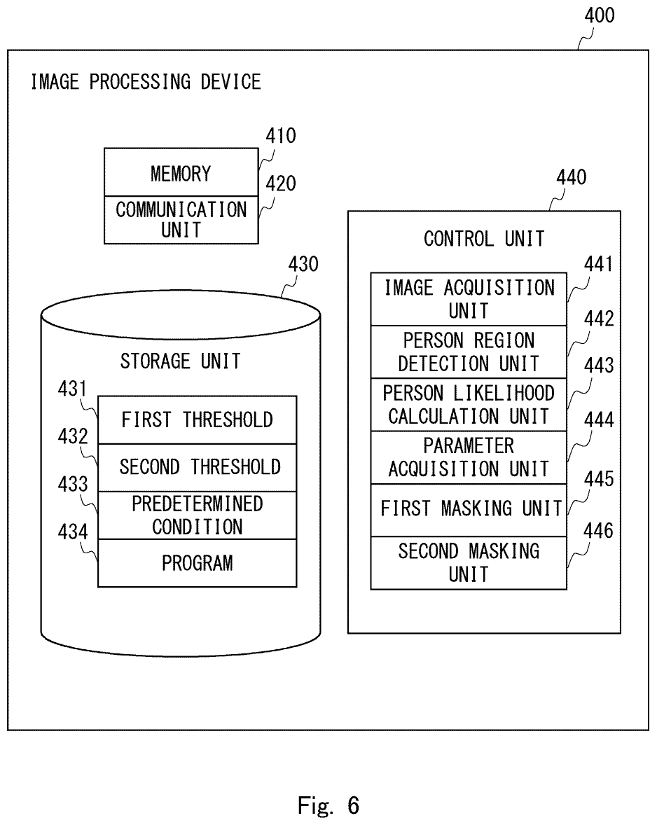

Next, a configuration of the image processing device 400 will be described in detail with reference to FIG. 6. FIG. 6 is a block diagram illustrating the configuration of the image processing device 400. The image processing device 400 includes a memory 410, a communication unit 420, a storage unit 430, and a control unit 440.

The memory 410 is a storage area for temporarily storing processing content of the control unit 440, and is, for example, a volatile storage device such as a random access memory (RAM). The communication unit 420 is an interface that communicates with the outside of the image processing device 400. The storage unit 430 is a storage device that stores a first threshold 431, a second threshold 432, a predetermined condition 433, and a program 434. The first threshold 431 of the person likelihood for the detection object can be, for example, 70% or 80%, and is a numerical value used when a first masking unit 445 (to be described later) determines whether to mask a person detected from a frame included in the video. The first threshold 431 of the person likelihood for the detection object may be set to a different value for each frame or according to a region in the frame. The second threshold 432 of the person likelihood can be, for example, 20% or 30%. In a case where the calculated person likelihood is less than the second threshold 432, the first masking unit 445 determines that the detected object is not a masking processing target, and refrains from performing the masking processing. The predetermined condition 433 includes a range and a condition of a parameter for an imaging environment in which the person (detection object) is appropriately included within the person region (bounding box). The program 434 is a computer program in which image processing treatment according to the present example embodiment is implemented.

The control unit 440 includes an image acquisition unit 441, a person region detection unit 442, a person likelihood calculation unit 443, a parameter acquisition unit 444, a first masking unit 445, and a second masking unit 446. The control unit 440 is a control device that controls an operation of the image processing device 400 and is, for example, a processor such as a CPU. The control unit 440 loads the program 434 from the storage unit 430 into the memory 410 and executes the program. Thus, the control unit 440 achieves functions as the image acquisition unit 441, the person region detection unit 442, the person likelihood calculation unit 443, the parameter acquisition unit 444, the first masking unit 445, and the second masking unit 446.

The image acquisition unit 441 acquires the video transmitted from the imaging device 310. The video includes a plurality of consecutive frames. The video may include identification information, time information, and positional information. The identification information is information for identifying the vehicle 300 in which the imaging device 310 that captures the video is provided. The time information is information regarding a time when the video is captured. The positional information includes the position of the vehicle at each time when the video (image) is captured.

The person region detection unit 442 detects the person region for each frame included in the video acquired by the image acquisition unit 110. In some example embodiments, the person region detection unit 442 can also identify attributes (for example, age, gender, race, and the like) of a person. In the present specification, the machine learning may be deep learning, but the machine learning is not particularly limited.

The person likelihood calculation unit 443 calculates the person likelihood in the person region detected by the person region detection unit 442. The person likelihood calculation unit 443 calculates the likelihood of a person detected at the time of detecting the person region using the known person region detection engine. In general, the likelihood of a person is a value in a range of 0% to 100%, and the higher the value, the higher the probability that the detected object is a person. The person likelihood is also referred to as a person detection score. The person detection score has a higher numerical value in a region having a high possibility that a person exists, than another region. The threshold of a predetermined person detection score is a preset numerical value and is used in a case where the person is detected from the frame included in the video. The threshold of the person detection score may be set to a value different according to the region in the frame. In the present specification, the machine learning may be deep learning, but the machine learning is not particularly limited. A method for calculating the person detection score is not limited to the above, and other existing technologies can be applied.

The parameter acquisition unit 444 acquires an environmental parameter at a time a video is captured. The parameter acquisition unit 444 may acquire sensor data from various sensors provided in the vehicle. The various sensors may be a speed sensor of a vehicle, a weather sensor, an optical sensor capable of acquiring ambient brightness, and the like, but are not limited to these.

In a case where the imaging environment parameter satisfies a predetermined condition and the person likelihood is equal to or more than a threshold (for example, 70% or more), the first masking unit 445 masks at least a part or all of the person region. On the other hand, in a case where the imaging environment parameter does not satisfy the predetermined condition and the person likelihood is less than the threshold (for example, less than 70%), the second masking unit 446 masks a range obtained by at least partially expanding the detected person region. In a case where the person likelihood is less than a first threshold (for example, less than 70%), there is a case where the detected person is not appropriately included within the bounding box. Therefore, in a case where the person likelihood is less than the first threshold (for example, less than 70%) and equal to or more than a second threshold (for example, 30% or more) smaller than the first threshold, the second masking unit 446 may mask a range obtained by at least partially expanding the detected person region. In a case where the person likelihood is less than the second threshold smaller than the first threshold (for example, less than 30%), the detected object is less likely to be a person, and thus may be excluded from the masking target (that is, the masking processing may be omitted).

In some example embodiments, the first masking unit 445 may perform masking processing on a part of the person region (for example, a part corresponding to the face or clothing, or the like). The second masking unit 446 may perform masking processing on a part (for example, a part corresponding to the face, clothing, or the like) of the range obtained by expanding the person region. The masking processing includes filling, mosaicing, or blurring. The masking processing can be replaced with an avatar corresponding to the attribute of the person while complying with personal information protection.

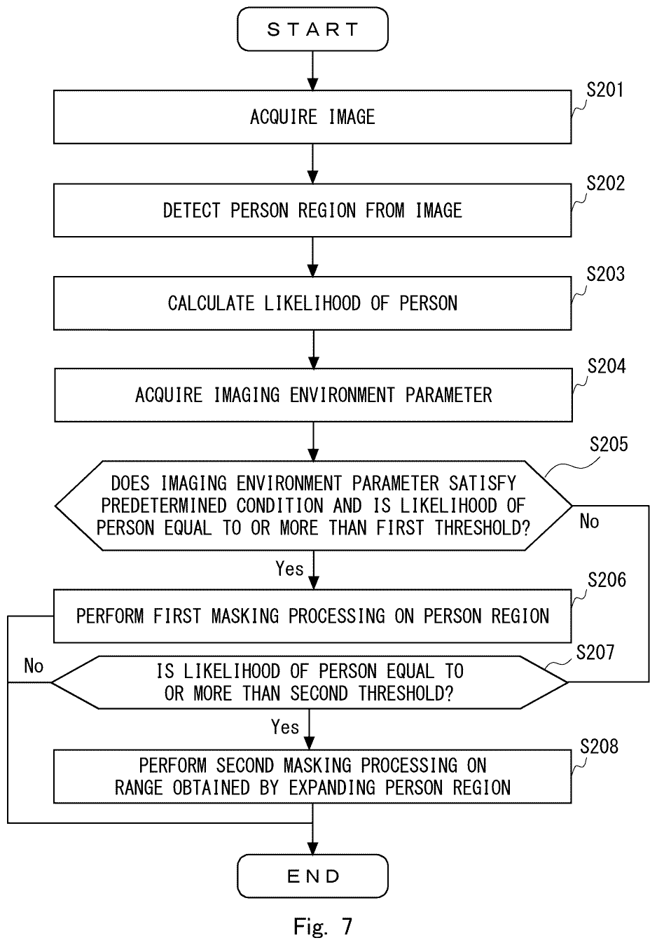

Next, an image processing method according to the second example embodiment will be described with reference to FIG. 7.

The image acquisition unit 441 acquires image frames of a video captured by the imaging device provided in the vehicle (step S201). The acquired image frames are stored in the storage device together with an acquired time and an acquired positional information (for example, latitude, longitude, and the like).

The person region detection unit 442 detects a person region estimated to be a person from the video acquired by the image acquisition unit 441 using the known person region detection engine (step S202). The person likelihood calculation unit 443 calculates the likelihood of a person detected at the time of detecting the person region using the known person region detection engine (step S203). In general, the person region detection and the person likelihood calculation can be simultaneously executed using the person detection engine. The parameter acquisition unit 444 acquires an imaging environment parameter when an image is captured by the imaging device (step S204).

In a case where an acquired imaging environment parameter satisfies a predetermined condition and the person likelihood is equal to or more than a first threshold (that is, in a case where the detected person is appropriately included within the bounding box and in a case where the probability that the detected object is a person is high) (Yes in step S205), the first masking unit 445 masks at least a part or all of the person region (step S206). Thus, in a case where the probability that the detected object is a person is high, it is possible to perform concealment processing on the person correctly included within the bounding box in the image frame using the person region detection engine. Thereafter, the image processing ends.

On the other hand, in a case where the imaging environment parameter does not satisfy a predetermined condition, or in a case where the calculated likelihood of a person is less than a first threshold (for example, 70%) (No in step S205), and in a case where the person likelihood is equal to or more than a second threshold (for example, 20%) (Yes in step S207), the masking processing is performed on a range obtained by expanding the person region (step S208). Thus, it is possible to ensure personal information protection using the person region detection engine in a case where the person is not appropriately included within the bounding box in the image frame or in a case where the probability that the detected object is a person is relatively low. Even in a case where the accuracy of the person region detection engine is not good (for example, due to external environmental factors such as weather), it is possible to perform masking processing without excluding a person whose personal information is to be protected.

In a case where the calculated likelihood of a person is less than the second threshold (for example, 20%) (that is, in a case where the probability that the detected object is a person is very low) (No in step S207), it is determined that the detected object is not a person, and the masking processing can be skipped. Thus, the collected images can be used for many purposes.

In the above-described example embodiments, the configuration of the hardware has been described, but the present disclosure is not limited thereto.

According to the present disclosure, the processing illustrated in FIGS. 4 and 7 can also be achieved by causing a CPU to execute a computer program.

In the example described above, the program includes a group of instructions (or software codes) for causing a computer to execute one or more functions described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or another memory technology, a CD-ROM, a digital versatile disc (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. As an example and not by way of limitation, transitory computer-readable or communication media include electrical, optical, acoustic, or other forms of propagated signals.

Note that the present disclosure is not limited to the above-described example embodiments, and can be appropriately changed without departing from the scope. The present disclosure may be implemented by appropriately combining the example embodiments. The functions of the image acquisition unit 110, the person region detection unit 120, the parameter acquisition unit 130, the first masking unit 140, and the second masking unit 150 of the image processing device 100 may be provided in the imaging device 310 of each vehicle 300. Similarly, the functions of the person region detection unit 442, the person likelihood calculation unit 443, the parameter acquisition unit 444, the first masking unit 445, and the second masking unit 446 of the image processing device 400 may be provided in the imaging device 310 of each vehicle 300.

Thus, the imaging device 310 of each vehicle 300 can individually detect a person and execute masking processing.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

Some or all of the above-described example embodiments may also be described as the following supplementary notes, but are not limited to the following supplementary notes.

### Supplementary Note 1

An image processing device including:
an image acquisition unit that acquires an image;
a person region detection unit that detects a person region estimated to be a person from the image;
a parameter acquisition unit that acquires an imaging environment parameter when the image is captured by an imaging device;
a first masking unit that masks at least a part of the person region in a case where the imaging environment parameter satisfies a predetermined condition; and
a second masking unit that masks a range obtained by at least partially expanding the person region in a case where the imaging environment parameter does not satisfy the predetermined condition.

### Supplementary Note 2

The image processing device according to Supplementary Note 1, in which the predetermined condition is a condition related to a speed of a vehicle when an image is captured by an imaging device provided in a vehicle.

### Supplementary Note 3

The image processing device according to Supplementary Note 1, in which the predetermined condition is a condition related to weather at a position of a vehicle when an image is captured.

### Supplementary Note 4

The image processing device according to Supplementary Note 1, in which the predetermined condition is a condition related to a time when an image is captured.

### Supplementary Note 5

The image processing device according to Supplementary Note 1, in which the predetermined condition is a condition related to data from a sensor provided in a vehicle.

### Supplementary Note 6

The image processing device according to Supplementary Note 1, in which the masking includes filling, mosaicing, or blurring on at least a part of the person region.

### Supplementary Note 7

The image processing device according to Supplementary Note 1, in which the masking includes disposing an avatar corresponding to an attribute of the detected person on the person region.

### Supplementary Note 8

The image processing device according to Supplementary Note 1, further including a person likelihood calculation unit that calculates likelihood of a person detected at a time of detecting the person region,
in which in a case where the likelihood of the person is equal to or less than a threshold, the second masking unit masks a range obtained by expanding the person region.

### Supplementary Note 9

An image processing method including:
acquiring an image;
detecting a person region estimated to be a person from the image;
acquiring an imaging environment parameter when the image is captured by an imaging device;
masking at least a part of the person region in a case where the imaging environment parameter satisfies a predetermined condition; and
masking a range obtained by at least partially expanding the person region in a case where the imaging environment parameter does not satisfy the predetermined condition.

### Supplementary Note 10

A non-transitory computer-readable medium storing a program that causes a computer to:
acquire an image;
detect a person region estimated to be a person from the image;
acquire an imaging environment parameter when the image is captured by an imaging device;
mask at least a part of the person region in a case where the imaging environment parameter satisfies a predetermined condition; and
mask a range obtained by at least partially expanding the person region in case where the imaging environment parameter does not satisfy the predetermined condition.

### REFERENCE SIGNS LIST

10 frame
30 person
40 vehicle
50 roadway
100 image processing device
110 image acquisition unit
120 person region detection unit
130 parameter acquisition unit
140 first masking unit
150 second masking unit
400 image processing device
410 memory
420 communication unit
430 storage unit
431 first threshold
432 second threshold
433 predetermined condition
434 program
440 control unit
441 image acquisition unit
442 person region detection unit
443 person likelihood calculation unit
445 first masking unit
446 second masking unit
200 image processing system
300 vehicle
310 imaging device
311 imaging unit
312 communication unit
320 recording device
321 measurement unit
322 communication unit
500 network
R1 person region
R2 expansion region

What is claimed is:

1. An image processing device comprising:
at least one memory storing instructions, and at least one processor configured to execute the instructions to:
an acquire an image;
a detect a person region estimated to be a person from the image;
a parameter acquire an imaging environment parameter when the image is captured by an imaging device;
mask at least a part of the person region in a case where the imaging environment parameter satisfies a predetermined condition; and
a mask a range obtained by at least partially expanding the person region in a case where the imaging environment parameter does not satisfy the predetermined condition.

2. The image processing device according to claim 1, wherein the predetermined condition is a condition related to a speed of a vehicle when an image is captured by an imaging device provided in a vehicle.

3. The image processing device according to claim 1, wherein the predetermined condition is a condition related to weather at a position of a vehicle when an image is captured.

4. The image processing device according to claim 1, wherein the predetermined condition is a condition related to a time when an image is captured.

5. The image processing device according to claim 1, wherein the predetermined condition is a condition related to data from a sensor provided in a vehicle.

6. The image processing device according to claim 1, wherein the masking includes filling, mosaicing, or blurring on at least a part of the person region.

7. The image processing device according to claim 1, wherein the masking includes disposing an avatar corresponding to an attribute of the detected person on the person region.

8. The image processing device according to claim 1, wherein the at least one processor is configured to execute the instructions to: calculate likelihood of a person detected at a time of detecting the person region, and
in a case where the likelihood of the person is equal to or less than a threshold, mask a range obtained by expanding the person region.

9. An image processing method comprising:
acquiring an image;
detecting a person region estimated to be a person from the image;
acquiring an imaging environment parameter when the image is captured by an imaging device;
masking at least a part of the person region in a case where the imaging environment parameter satisfies a predetermined condition; and
masking a range obtained by at least partially expanding the person region in a case where the imaging environment parameter does not satisfy the predetermined condition.

10. A non-transitory computer-readable medium storing a program that causes a computer to:
acquire an image;
detect a person region estimated to be a person from the image;
acquire an imaging environment parameter when the image is captured by an imaging device;
mask at least a part of the person region in a case where the imaging environment parameter satisfies a predetermined condition; and
mask a range obtained by at least partially expanding the person region in a case where the imaging environment parameter does not satisfy the predetermined condition.
